(19) United States
(12) Patent Application Publication
(10) Pub. No.: US 2017/0228832 A1
(43) Pub. Date: Aug. 10, 2017

(54) AUTOMATED FARMING SYSTEM AND METHOD

(71) Applicant: Craig B. Tuttle, Scott City, KS (US)

(72) Inventor: Craig B. Tuttle, Scott City, KS (US)

(21) Appl. No.: 15/425,895

(22) Filed: Feb. 6, 2017

Related U.S. Application Data
(60) Provisional application No. 62/291,980, filed on Feb. 5, 2016.

(51) Int. Cl. G06Q 50/02; G06Q 30/06; G05B 15/02; G06Q 40/00

(52) U.S. Cl. CPC G06Q 50/02; G06Q 40/12; G06Q 30/0645; G05B 15/02

(57) ABSTRACT

An automated farming system includes equipment operating on a cropland. The equipment includes a yield monitor for dynamically measuring crop yields, and a communications subsystem for wirelessly reporting data corresponding to the crop yields. The communication subsystem can interactively control operation of the equipment, for example, providing guidance via a global navigation satellite system (e.g., the Global Positioning System (GPS)). A computer interfaces with the equipment and is programmed with a dynamic rent computing function, which utilizes the inputs and cropland outputs comprising crop yields for computing an appropriate rent for the cropland based on variable factors including crop yields, commodity prices, operating costs and by applying an operating margin allocation between the landowner and the farmer.

### CROSS-REFERENCE TO RELATED APPLICATION

This application claims priority in U.S. Provisional Patent Application No. 62/291,980, filed February 5, 2016, which is incorporated herein by reference.

### BACKGROUND OF THE INVENTION

1. Field of the Invention

The present invention relates generally to automated farming systems and methods, including sensing devices for monitoring variables, controlling system components and dynamically computing parameters.

2. Description of the Related Art

In the field of agriculture, automation can increase efficiency and reduce operating costs. For example, farmers generally incur significant expenses for “inputs,” which generally comprise resources expended in crop production. Farmers incur input costs for such resources as seed, fuel, equipment, fertilizer, pesticides (e.g., insecticides and herbicides) and labor. Moreover, interest and insurance costs are commonly incurred by farmers. Farmers typically make many business decisions during a season, which are based on experience and predictions of future factors and variables affecting an operation and its revenue.

Cropland expenses are another major cost category for many farmers. Various rent models have previously been utilized. For example, fixed amounts can be agreed upon in advance. Alternatively, rents are often based on percentages of revenue and/or crop yields.

Historical (legacy) rents, competitive alternatives, productivity, natural resources, accessibility and location (e.g., proximity to other commonly-farmed parcels) are also factors. However, agricultural revenue is susceptible to factors which can vary considerably from season-to-season. For example, crop yields and commodity prices are variable. Input costs for seed, fertilizer, pesticides, feed, fuel, labor and other operating costs vary considerably. Insurance and interest costs can also vary.

On the revenue or output side, income from farming operations is largely based on crop market values. Such values are generally a function of commodity prices and yields. Global market conditions often have international effects, and are susceptible to political, tariff and other influences. Methods for protecting against the effects of fluctuating farm income include futures trading, crop insurance and investing in commodity markets.

Due to the effects of such input-output variables, previous rent models were susceptible to errors, such as overpayments and underpayments, with significant financial consequences. Heretofore there has not been available a system or method for automating farming operations, including dynamically determining appropriate rent with an effective rent model for croplands with the advantages and features of the present invention.

### BRIEF SUMMARY OF THE INVENTION

The automated farming system of the present invention generally includes a computer network programmed for receiving input data corresponding to agricultural operation factors and variables, and providing output data for controlling various physical, financial and operational aspects of the farming operation. The system includes a dynamic rent model for computing an appropriate rent for cropland, which is based on yields, which can be averaged for allocating risks and opportunities between landowners and farmers. The dynamic rent model is also based on commodity prices and operating costs. As such variables change due to market and other conditions, the dynamic rent model can update the outputs in real-time.

### BRIEF DESCRIPTION OF THE DRAWINGS

The drawings constitute a part of this specification and include exemplary embodiments of the present invention illustrating various objects and features thereof.

FIG. 1 is a block diagram of an automated farming system embodying an aspect of the present invention.

FIG. 2 is a chart showing an application of a dynamic rent model of the present invention to an exemplary crop (commodity), such as wheat.

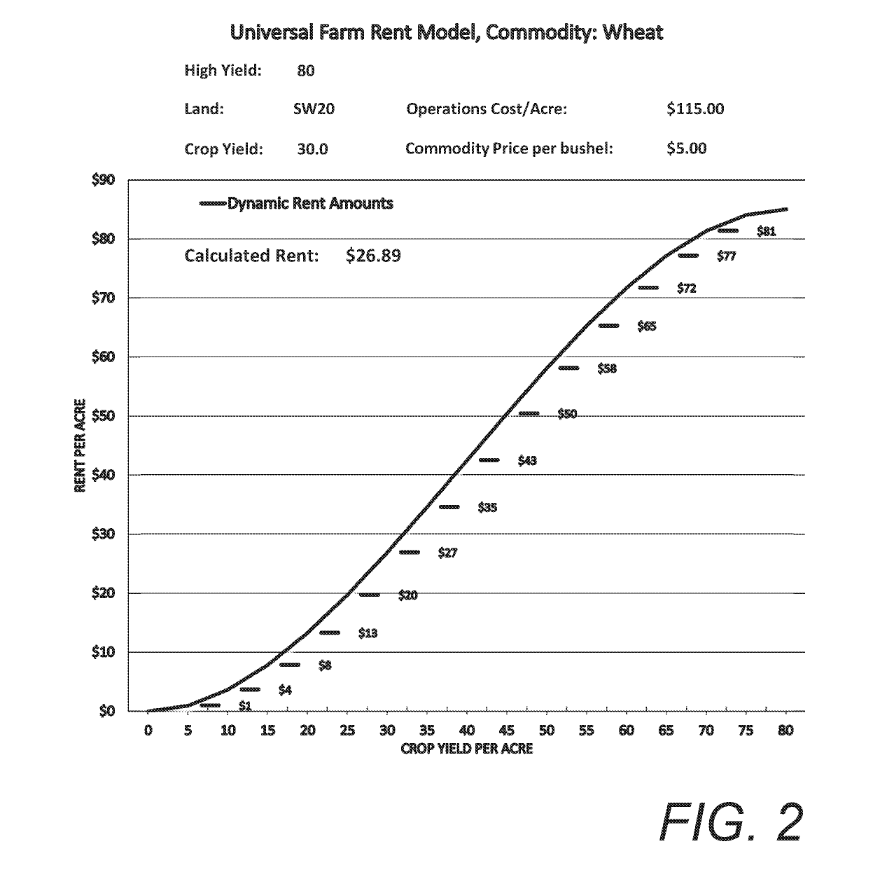

FIG. 3 is a chart showing another application of the dynamic rent model with different variables.

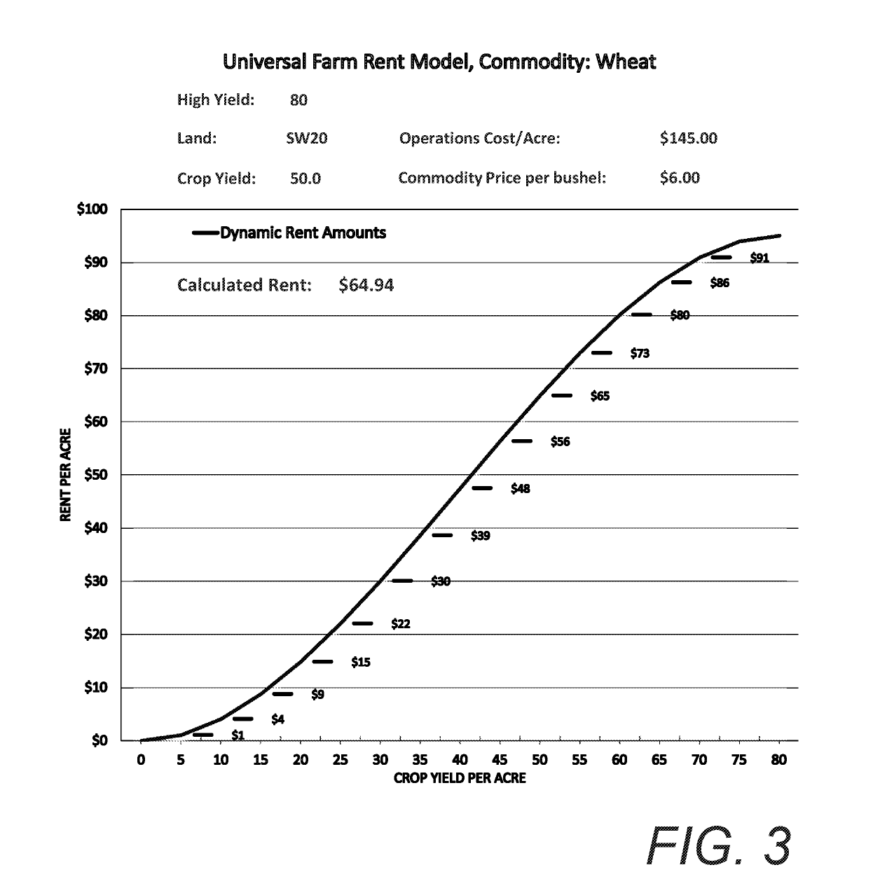

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. Said terminology will include the words specifically mentioned, derivatives thereof and words of similar meaning.

### II. Automated Farming System 2

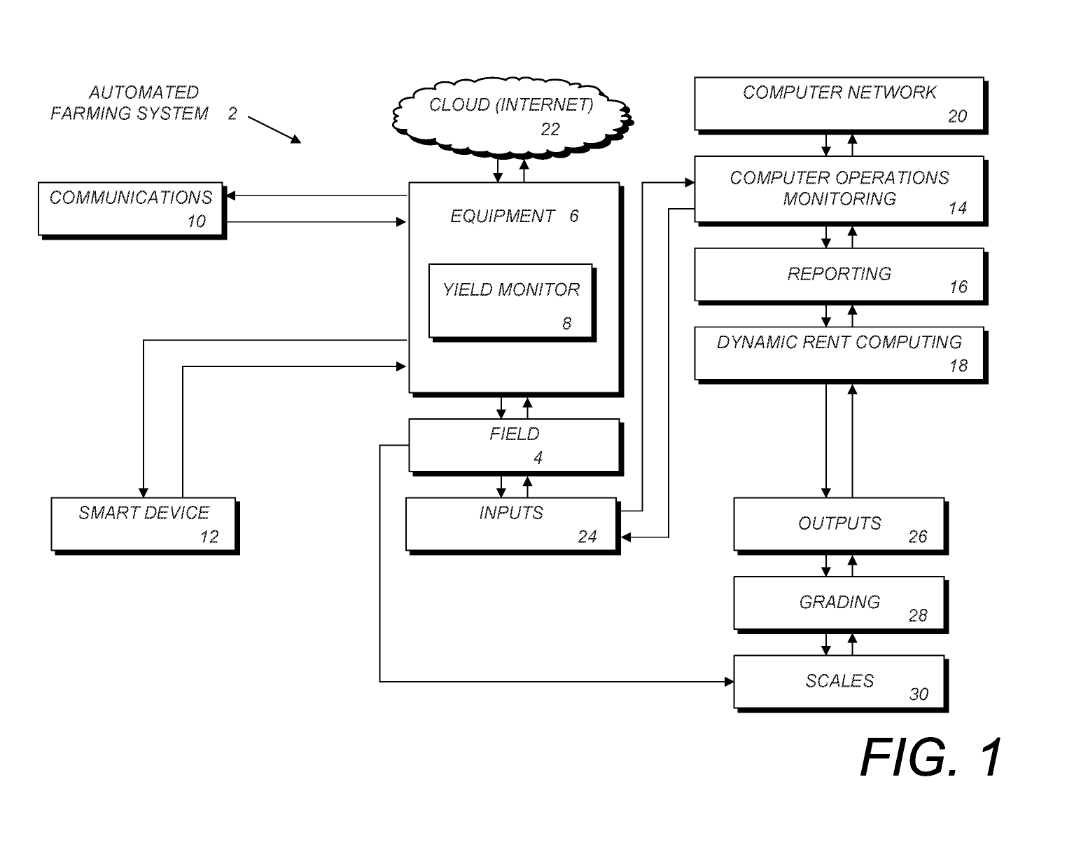

Referring to FIG. 1, the automated farming system 2 generally includes a field 4 comprising cropland. Multiple fields 4 can be collectively automated by the system 2. The equipment 6 operating on the field 4 can comprise any suitable equipment, including vehicles and implements for cultivating, planting, spraying, harvesting and other agricultural operations. Harvesting equipment can include a yield monitor 8 for quantifying crop yields in real-time while harvesting.

The equipment 6 can remotely interface with a communications subsystem 10. For example, radio frequency (RF) and wireless telecommunications can be utilized. “Smart” devices 12, typically combining mobile communications, data receiving-transmitting functions (e.g., Global Positioning System (GPS)), can remotely interface with the equipment 6.

A computer network 20 can interface with a computer 14 monitoring the operation, and includes and output reporting function 16. The system 2 also includes a dynamic rent computing function 18, which will be explained in more detail below. Outputs 26 can be configured for crop-specific functions, such as grading 28 and weighing crops with scales 30, e.g., in a combine. In many farming operations harvested crops are weighed as part of a valuation process.

The system 2 can interface with the Internet via the “Cloud” at 22 whereby data corresponding to the crop inputs 24 and outputs 26 can be utilized in the computer operations monitoring function 14. For example, input resources expended and crop yields produced can be monitored, reported and used dynamically in the system 2, for example in adjusting the dynamic rent model at 18. Thus, cropland rent can be adjusted in real-time to account for actual operating conditions based on current variable data. Typically, such data varies over the course of a growing season and the variables are factored in to determine and maintain appropriate rents.

### III. Calculating the Dynamic Rent Model

The dynamic rent model of the present invention is calculated as follows.

Variables:
Y—Yield (Ex. Bushels/Acre=50), values between zero and 2*A.

A=Y/2.
P—Price of commodity, (Ex. $6.00 per Bushel), values may be>zero to infinity.
O—Operating Cost (Ex. Dollars per Acre=$200), >zero to infinity.
Negative Rent is a valid calculation if, at a given yield, Operating Costs are greater than (P*A). Crop production can use the Dynamic Rent Model to forecast profits (or losses) to determine the best plan of action. For example, crop insurance and other crop program revenues may be included to change the Effective Price of the yield to create a positive Rent.
Rent Formula:

$$Rent = \frac{Y}{A} * \frac{PA - O}{2 PA} * PY * \frac{2 A - Y + A}{2 A} .$$

Simplifying yields:

$$Rent = \frac{{Y}^{2} ( PA - O ) ( 3 A - Y )}{4 {A}^{3}} .$$

It is to be understood that while certain embodiments and/or aspects of the invention have been shown and described, the invention is not limited thereto and encompasses various other embodiments and aspects.

1. A system for automating an operation for farming cropland with mobile equipment configured for applying inputs to and harvesting crops from said cropland, which system includes:
a computer configured for monitoring the farming operation;
said computer configured for monitoring inputs applied to the cropland and monitoring crop yields produced in the farming operation;
said computer programmed with a dynamic rent model utilizing said inputs and outputs for dynamically determining a cropland rent based on a predetermined allocation of an operating margin from said operation;
said inputs including operating costs and expenses associated with said cropland;
said outputs comprising crop yields; and
said computer configured for dynamically computing said operating margin from said inputs and outputs.

2. The system according to claim 1, which includes a rent model installed on said computer with the following formula:
$$Rent = \frac{{Y}^{2} ( PA - O ) ( 3 A - Y )}{4 {A}^{3}}$$
Wherein:
Y=Yield (Bushels/Acre), values between zero and 2*A;
A=Y/2;
P—Price of commodity ($), values between zero and infinity; and
O—Operating Cost ($ per Acre), values between zero and infinity.

3. The system according to claim 2 wherein said computer calculates an effective price for a crop based on yield, commodity price and operating cost.

4. The system according to claim 3 wherein said effective price in said rent model is increased by crop insurance or crop program revenues.

5. The system according to claim 4 wherein said mobile equipment includes an on-board yield monitor configured for calculating crop yield simultaneously with said equipment harvesting the crop from said field.

6. The system according to claim 5 wherein:
said inputs include crop weight data derived from weighing said crop at a location remote from said field.

7. The system according to claim 5 wherein:
said inputs include crop grading data derived from grading said crop at a location remote from said field.

8. The system according to claim 1, which includes a smart device located remotely from said equipment and configured for:
wirelessly receiving operating data from said equipment; and
wirelessly transmitting instructions to said equipment.

9. The system according to claim 2, which includes:
a computer network connected to said computer and configured for remotely monitoring and controlling the operations of multiple equipment units.

10. The system according to claim 2 wherein said equipment is wirelessly connected to the Internet via the cloud and transmits data to and receives data from the Internet whereby the operation of said equipment is monitored, reported, and controlled.

11. A system for automating an operation for farming cropland with mobile equipment configured for applying inputs to and harvesting crops from said cropland, which system includes:
a computer configured for monitoring the farming operation;
said computer configured for monitoring inputs applied to the cropland and monitoring crop yields produced in the farming operation;
said computer programmed with a dynamic rent model utilizing said inputs and outputs for dynamically determining a cropland rent based on a predetermined allocation of an operating margin from said operation;
said inputs including operating costs and expenses associated with said cropland;
said outputs comprising crop yields;
said computer configured for dynamically computing said operating margin from said inputs and outputs;
a rent model installed on said computer with the following formula:
$$Rent = \frac{{Y}^{2} ( PA - O ) ( 3 A - Y )}{4 {A}^{3}}$$
Wherein:
Y=Yield (Bushels/Acre), values between zero and 2*A;
A=Y/2;
P—Price of commodity ($), values between zero and infinity; and
O—Operating Cost ($ per Acre), values between zero and infinity;
said computer calculating an effective price for a crop based on yield, commodity price and operating cost;
said effective price in said rent model being increased by crop insurance or crop program revenues;
said mobile equipment including an on-board yield monitor configured for calculating crop yield simultaneously with said equipment harvesting a crop from said field;
said inputs including crop weight data derived from weighing said crop at a location remote from said field;
a smart device located remotely from said equipment and configured for: wirelessly receiving operating data from said equipment; and wirelessly transmitting instructions to said equipment;
said inputs including global navigation satellite system (GNSS) positioning signals corresponding to equipment positioning; and
said equipment being wirelessly connected to the Internet via the cloud and configured for transmitting data to and receiving data from the Internet whereby the operation of said equipment is monitored, reported and controlled.

12. A method of automating a farming operation using the system described above.
